(19) United States
(12) Patent Application Publication
(10) Pub. No.: US 2026/0306978 A1
(43) Pub. Date: Oct. 8, 2026

(54) METHOD OF FILTRATION OF PARTICULATED SYSTEMS WITH INJECTION OF NANOBUBBLES, AND, USE

(71) Applicants: Vale S.A., Rio de Janeiro (BR); Universidade Federal Do Rio Grande Do Sul- UFRGS, Porto Alegre (BR)

(72) Inventors: André Camargo DE AZEVEDO, Porto Alegre (BR); Jorge Rubio ROJAS, Porto Alegre (BR); Neymayer Pereira LIMA, Ouro Preto (BR)

(21) Appl. No.: 19/480,764

(22) PCT Filed: May 2, 2024
(86) PCT No.: PCT/BR2024/050178

§ 371 Date: Oct. 31, 2025

(30) Foreign Application Priority Data
May 3, 2023 (BR) 1020230084419

(51) Int. Cl. B01D 37/02; B01D 39/18

(52) U.S. Cl. CPC B01D 37/02; B01D 39/18; B01D 2239/1216; B01D 2257/55; B01D 2257/60

(57) ABSTRACT

The present invention describes a method for filtering particulate systems. The dewatering of particulate solids according to the present invention is carried out using ultrafine bubbles injected into the filtration feed line, to reduce or eliminate the need to use additive filtration reagents (coagulants, flocculants and/or surfactants), with benefits in terms of increasing filtration speed (cake permeability) and reducing residual cake moisture.

### FIELD OF INVENTION

The present invention is inserted in the field of nanotechnology, more precisely in nanobubble technologies. The invention suggests a filtration technique for particulate systems (such as mineral slurries) that uses nanobubble injection in the filtration dewatering stages, particularly in the slurry of tailings and mineral concentrates prior to filtration in filter presses or vacuum filters.

### BACKGROUND OF THE INVENTION

Filtration processes for mineral systems containing fine and ultrafine particles generally use high pressures in filter presses to remove the particles, and require the addition of additive filtration reagents (coagulants, flocculants and/or surfactants) that increase the cost of these processes and generate an increase in the volume of chemical compounds discharged into the environment, which goes against the environmental trend of dewatering tailings for dry disposal or reuse without the use of dams.

It is therefore necessary to develop filtration technology that can reduce or eliminate the need to use additive reagents in dewatering operations (filtration), while also reducing the cost of dewatering, also reducing energy costs (due to the use of lower operating pressures) and the time needed to filter particulate systems.

Nanobubbles (NBs) are recognized as dispersed entities in aqueous media, such as pure water or surfactant solutions (bulk NBs), or as interfacial or surface NBs, adsorbed and spread as pancake-like structures on solid surfaces.

The first reports of the existence of NBs dispersed in liquid media arose following speculation that some tiny gas units (smaller than approximately 1 μm), stabilized by organic films, would serve as nuclei for the growth of microbubbles during cavitation processes.

Research into nanobubbles (bubbles with a diameter of less than 1 μm, as defined by ISO Standard 20480-1:2017) has been growing rapidly, and many applications have been reported: in the environmental field, nanobubbles can be used to enhance the removal of a variety of pollutants (emulsified oil, colloidal solids, organic/inorganic precipitates, ions) by flotation associated with larger bubbles. In addition, isolated nanobubbles can be applied to the removal of residual pollutants such as amine and oil (both as flocs). Furthermore, the use of ozone and oxygen nanobubbles has been studied for the remediation/decontamination of soils and aquatic ecosystems and for the oxidation of emerging pollutants in the treatment of water and effluents. The application of nanobubbles has also been studied, for example, in medicine, surface cleaning, water and wastewater treatment, energy systems, fluid microdynamics, engineering and science of materials, flotation processes and cosmetic and aesthetic treatments.

The main characteristics of nanobubbles are: high stability (dispersed in liquids or adhered to solid surfaces); affinity for hydrophobic surfaces; high interface area per unit volume of liquid; the interaction with organic molecules/surfactants and modulation of their surface charge in surfactant and/or electrolyte solutions.

There are several patents, procedures and techniques for generating nanobubbles reported in the state of the art. However, most of these publications that report on nanobubble generation devices do not provide information on measurements of bubble size distribution or concentration. In addition, there is a problem of scale and many of these products are small discontinuous bench-top platforms, difficult to scale up, which can serve small-scale purposes, but are not capable of treating high-flow effluents or mineral slurries on an industrial scale.

In this regard, document KR101716081 (B1) refers to a membrane filtration device that performs filtration and washing at the same time by introducing inlet water and nanobubbles together in a hollow fiber membrane module for a membrane filtration process with a high processing rate, and to a method using the same. This document discusses the application of nanobubbles in the ultra- and microfiltration membrane separation process for water treatment, but without detailing the nanobubble generation device.

Document KR101157477 (B1) refers to the use of microbubbles and nanobubbles in the backwash water of deep bed filters for water treatment. In this document, a binary backwashing system using micro- and nanobubbles is provided to reduce the time required for a cleaning process and to clean foreign materials from a filter by uniformly distributing air nanobubbles in the filter pores. These filters are characterized by particulate beds of sand, anthracite, gravel and/or activated carbon and are different from the filters used in ore treatment, both in terms of process objectives and filtration technologies.

In turn, document WO2021120370 A1 deals with a nanobubble flotation column, which generates nanobubbles in the ore slurry that flows through the slurry pump, a nano-cavitation bubble nozzle and a turbulent jet. In addition, a turbulent jet bubble nozzle and a turbulent jet nozzle are used to improve the mineral recovery rate, quality and efficiency and reduce chemical dosage and energy consumption.

Document BR112020023010-3 A2 deals with a tank-type flotation cell for treating particles suspended in fluid paste, with the aim of concentrating and separating particles containing valuable material. The microbubbles generated, which have a diameter of between 100 and 800 micrometers (around 1000 times larger than the nanobubbles generated by hydrodynamic cavitation), are injected into the equipment for mechanical cell flotation.

Also, in the document Azevedo, A., Etchepare, R., Paiva, M., Rosa, A. F., Rubio, J., 2016. Featuring the nanobubbles scenario in mining and mineral flotation. 24th World Mining Congress Proceedings/Instituto Brasileiro de Mineraçǎo (Org). 1 ed.—Rio de Janeiro: IBRAM, 2016b presents the research and technology scenario in NBs for mineral treatment. This document uses nanobubbles in the presence or absence of microbubbles, in different systems, to investigate their effects on the flotation of mineral particles and/or the treatment of process water, using sulfide copper and gold ores for the studies, but does not apply NBs in mineral slurry dewatering (filtering) operations.

Thus, there are no reports in the prior art that anticipate a method that uses the injection of ultra-fine bubbles (nanobubbles) in the dewatering (filtration) of mineral slurries.

### SUMMARY OF THE INVENTION

The present invention relates to a method for filtering particulate systems using ultrafine bubble injection.

The primary objective of the invention presented is to provide a filtration method that uses the injection of ultrafine bubbles (nanobubbles) in the dewatering of mineral slurries, particularly in the filtration of ultrafine tailings slurry and concentrates.

The second objective of the present invention is to provide a filtration method that uses the injection of ultrafine bubbles (nanobubbles) in the dewatering of mineral slurries in press filters or vacuum filters, to reduce or eliminate the need to use additive filtration reagents (coagulants, flocculants and/or surfactants).

Advantageously, the generation of nanobubbles can be carried out directly in the slurry or in the slurry dilution water, depending on the dewatering circuit used to apply the technique. In addition, the technology proposed here can cover filtration processes with cake formation in a broad way, as a method of pre-treating the slurry, regardless of the filtration equipment used.

The proposed method uses the mechanisms of hydrophobization and micro-aggregation of fine particles provided by nanobubbles (Azevedo, A., Etchepare, R., Paiva, M., Rosa, A. F., Rubio, J., 2016. Featuring the nanobubbles scenario in mining and mineral flotation. 24th World Mining Congress Proceedings/Instituto Brasileiro de Mineraçǎo (Org). 1 ed.—Rio de Janeiro: IBRAM, 2016b; Rosa, A. F., Rubio, J., 2018. On the role of nanobubbles in particle-bubble adhesion for the flotation of quartz and apatitic minerals. Minerals Engineering, Volume 127, 2018, pp 178-184) to increase the porosity of the cake and reduce the capillary pressure of water retention in its interstices, making it a viable alternative in ore treatment and environmental technology processes.

In the technique covered by this invention, it is proposed to inject nanobubbles into the ultrafine particle slurry to achieve the effect of increasing the filtration speed, reducing or eliminating the consumption of additive reagents and/or the operating pressure of the feed pump.

The better filtration time or higher flow velocity of the liquid in the presence of nanobubbles is explained mainly by two phenomena. The first is the adhesion of the bubbles to the surfaces, generating an aggregation of the particles to be filtered, and the second is the decrease in interfacial wettability (film/film of water at the solid/liquid interface, due to the hydrophobic nature of the nanobubbles). The first mechanism increases porosity in the cake and the second facilitates liquid flow by reducing capillary pressure in the pore voids and interstices between the particles.

The layout of the technique in industrial applications has different variations and alternatives in terms of how the bubbles are generated and where they are injected into the slurry before filtration.

The proposed method can use a variety of techniques for generating nanobubbles, already referenced in the literature, such as: hydrodynamic cavitation, using in-line flow constrictors (venturi tube, orifice plates or needle valves), and/or acoustic cavitation (ultrasonic), through the energy stimulus produced by an ultrasonic device in the slurry feed line.

The main benefits of scaling up the technique are related to the following factors:
a) Higher productivity: increased capacity (mass of solids recovered per m² of filter media) of filter presses or vacuum filters for dewatering particles in concentrates and ultrafine tailings;
b) Cost reduction: lower dosages of additive reagents in ultrafine filtration and physical area of filters;
c) Environment: reduction of chemical compounds (additive reagents) in the filtration process water, with greater ease of recovery and reuse, in addition to being aligned with the objectives of dewatering tailings for dry disposal or reuse, without the use of dams.

These objectives and other advantages of the present invention will become clearer from the following description and the attached figures.

### BRIEF DESCRIPTION OF THE FIGURES

The detailed description below refers to the attached figures, in which:

FIG. 1 represents the schematic drawing of the experimental device from which the experimental data according to the present invention were obtained ((1) Saturator vessel (3.0 L); (2) Water inlet; (3) Compressed air inlet; (4) Air diffuser; (5) Pressure gauge; (6) Pressure relief valve with air filter; (7) Saturated water outlet; (8) Level viewer).

FIG. 2 shows the particle size distribution of the iron ore flotation tailings sample according to the present invention, analyzed by Laser Beam Diffraction.

FIG. 3 shows the particle size distribution of the A1 quartz sample (average diameter: 17 μm, D₁₀=1.4 μm, D₅₀=13 μm and D₉₀=40 μm) according to the present invention.

FIG. 4 shows the particle size distribution of quartz sample A2 (average diameter: 25 μm, D₁₀=2 μm, D₅₀=21 μm and D₉₀=57 μm), according to the present invention.

FIG. 5 shows the components of the filtration system used in the present invention: a) On the left, bench press filtration system; b) On the right, filter media support.

### DETAILED DESCRIPTION OF THE INVENTION

The present invention relates to the dewatering of particulate solids using ultrafine bubble injection.

### 1. Samples

The particulate solids according to the present invention can be selected from the most distinct granular materials (seeds, cereals, sands), powders (food, pharmaceutical, ores), dusts (pollutants, contaminants), and even nanoparticles. Preferably, the particulate solids according to the present invention can be mineral slurries selected from the most diverse types of ores, not limited to those originating from iron ore processing.

The present invention proposes that the dewatering operation of particulate solids be carried out using nanobubbles (ultrafine bubbles with an (approximate) diameter of less than 1 μm, as defined by ISO Standard 20480-1:2017) prior to filtration in filter presses or vacuum filters.

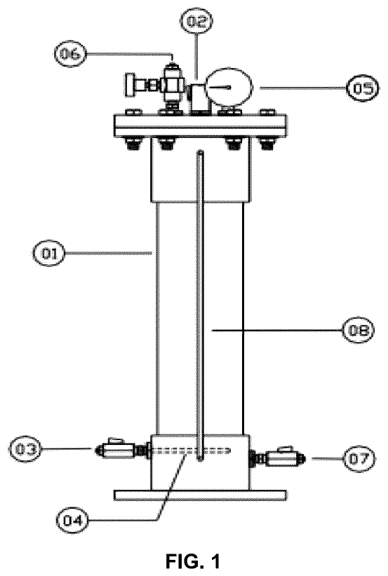

Initially, the descriptions presented refer to the experimental device shown in FIG. 1 and used to obtain the experimental data.

As can be seen in FIG. 1, in one form of the present invention, not restricted to this layout, the nanobubbles (NBs) were generated using a saturator vessel (1) coupled to a valve, by reducing the pressure of the fluid pre-saturated with compressed gas used to generate the NBs (selected from air, carbon dioxide, inert gas, oxygen or mixtures thereof) to a pressure between 2 and 6 bar, preferably between 2.5 and 3 bar, in order to maximize the rate of nanobubbles/microbubbles (NBs/MBs) generated in hydrodynamic cavitation.

Once the gas-saturated fluid flow has passed through the valve, selective separation of the microbubbles (MBs) generated concurrently during the process can occur, as the MBs have an upward velocity and reach the surface of the liquid. They reach the surface of the liquid, collapsing and leaving a dispersion of fluid containing a high concentration of NBs, in the order of around 1×10⁸ NBs·mL⁻¹ or more, preferably between about 1×10⁶ NBs·mL⁻¹ and about 10¹² NBs·mL⁻¹, particularly about 1×10⁷ NBs·mL⁻¹ and about 1×10¹² NBs·mL⁻¹.

In the filtration tests with the application of NBs, this fluid dispersion with a high concentration of NBs was used to prepare the dispersion of particulate solids to feed the filtration.

In the conditioning tests with additive filtration reagents, a solution with a surface tension between about 20 and about 72 mN·m⁻¹, preferably between about 20 and about 60 mN·m⁻¹, was used to generate NBs, resulting in a concentration of NBs of around 1×10⁹ NBs·mL⁻¹ or more, particularly between around 1×10⁶ NBs·mL⁻¹ and around 1×10¹² NBs·mL⁻¹, preferably between around 1×10⁷ NBs·mL⁻¹ and around 1×10¹² NBs·mL⁻¹.

### 2. Dewatering (Filtration):

In one embodiment of the invention, the method according to the present invention uses filter-press equipment with compressed gas pressurization (selected from air, carbon dioxide, inert gas, oxygen or mixtures thereof). The filtering system comprises a container holding the slurry to be filtered and a support chamber for the filtering medium, a gas cylinder responsible for producing the pressure acting on the filter, pressure regulators and a scale responsible for measuring the mass of filtrate leaving the filter over the time of the test.

The dewatering of particulate solids can be carried out under the following operating conditions:
pH: between about 6 and about 11, particularly between about 6.5 and about 9, preferably between about 7 and about 8;
operating pressure between about 0.1 and about 24 bar, particularly between about 2 and about 10 bar, preferably between about 5 and about 9 bar;
solids content in the slurry between around 20% and around 85% by mass, particularly between around 40% and around 70% by mass, preferably between around 45% and around 65% by mass of solids in the slurry.

In the studies on conditioning with additive filtration reagents, the material was conditioned to a pH between about 6 and about 12, particularly between about 6.5 and about 11, during slurry preparation. In the condition with NB injection, the bubbles were generated using the procedure described in item 1 of this section, using additive filtration reagents (coagulants, flocculants and/or surfactants) to fill the saturating equipment and generate a high concentration of NBs.

The experimental procedure begins with the preparation of the slurry at the concentration of interest, weighing the mass of solids and dispersing fluid. The mixture is stirred and the pH adjusted to the range described above (between about 6 and about 12, particularly between about 6.5 and about 11). After stirring, the volume of slurry is poured into the filter up to the defined mark and finally the filter medium is added to the support for coupling to the filter chamber, which is already filled with mineral slurry. The filter is then closed and placed on the support so that it is suspended over the scale. The pressure regulators are attached and adjusted to the working pressure.

When the operating pressure reaches the inside of the filter medium, the valve (7) is opened to allow the filtrate to escape and the timer is started. Filtering takes place from the opening of valve (7) until a puff of air appears, indicating that the flow of liquid has ceased and the drying stage has begun, which takes place over a period between about 0.5 and 5 minutes, particularly between about 1 and about 4 minutes.

During the cake formation time, the value of the weighed filtrate mass is recorded at intervals of between about 5 and about 30 seconds, preferably between about 10 and about 30 seconds, to calculate the filtering speed. The end of the filtration cycle stage corresponding to the cake formation time is identified by the blowing of the gas percolating the cake on the inside of the filter and the cessation of the dripping flow of filtrate.

After the cake has formed, a drying time of between about 0.5 and 5 minutes was maintained, particularly between about 1 and about 4 minutes in all the tests, in which the gas flow was kept constant at a fixed pressure (between about 0.1 and about 24 bar, particularly between about 2 and about 10 bar, preferably between about 5 and about 9 bar). At the end of the drying time, the gas cylinder is closed and the test is terminated. The filter mass together with the wet cake is weighed and set to dry at a temperature of between about 80° C. and about 150° C., preferably between about 90° C. and about 130° C. for a period of at least about 8 hours, particularly at least about 12 hours, preferably at least about 14 hours, more preferably at least about 16 hours. After the cake has dried, it is weighed again to calculate the moisture content of the cake after filtering.

After carrying out the tests without injecting the NBs, the same experimental procedure was repeated using the fluid with NBs (as described above) to prepare the slurry for filtering.

Thus, in general terms, the experimental method for filtering particulate systems according to the present invention comprises the following steps:
generate nanobubbles (NBs) through hydrodynamic cavitation techniques, after depressurizing the supersaturated liquid stream in compressed gas at a pressure between about 1 and about 15 bar, preferably between 2.5 and 3 bar, in a period between about 2 min and about 60 min;
promoting slurry conditioning/particle suspension in the presence of nanobubble dispersion (NBs) in the filtration feed line or auxiliary tanks;
dewatering the slurry/particle suspension in filtration equipment using positive pressure, negative pressure (vacuum) or both.

In one embodiment of the present invention, the method comprises generating NBs by alternative hydrodynamic cavitation methods (venturi tube, orifice plate and/or other flow constrictors) directly in-line in the slurry pipe feeding the unitary filtration operation.

In a further embodiment of the present invention, the method comprises the generation of NBs by alternative methods of ultrasonic cavitation (ultrasound device) directly in-line in the slurry pipe feeding the unitary filtration operation.

It should be noted that any modifications and adaptations that may be made to the experimental apparatus used, from which the experimental data on average velocity (or volumetric flow) and pressure difference are obtained, are permitted.

The terms “preferred” and “preferably” refer to modalities that can provide certain benefits in certain circumstances. However, other modalities may also be preferred in the same or other circumstances. Furthermore, the citation of one or more preferred modalities does not constitute an impediment to other modalities being used, nor does it exclude other modalities from the scope of the present invention.

The following description will start from preferred embodiments of the invention. As will be evident to anyone skilled in the art, the invention is not limited to these particular embodiments.

### Examples

Filtration parameters were measured for different fine-grained mineral samples:
i. Ultrafine iron ore tailings;
ii. Ultrafine iron ore concentrate and
iii. High purity quartz.

The aim was to evaluate the effect of injecting nanobubbles (NBs) into the filtration feed slurry, in relation to the cake formation time (filtration speed), in ultrafine mineral samples in slurry with 55 to 60% solids by mass. For quartz, the effect of injecting NBs in the filtration of samples with amine conditioning (Flotigam EDA) was also evaluated. The tests were carried out on a bench scale using a filter press and paper filter media (average pore size of 2 to 5 μm).

### I. Preparation of the Ultra-Fine Concentrate:

The ultrafine iron ore concentrate sample has the granulometric and chemical characterization described in Table 1.

TABLE 1
Particle size and chemical characterization of the ultrafine
iron ore concentrate used in the filtering tests.

| | Conc. | | |
|---|---|---|---|
| Mesh | Slon | | |
| 210.00 | 99.77 | | |
| 150.00 | 99.65 | | |
| 106.00 | 99.50 | Fe (%) | 60.19 |
| 75.00 | 97.84 | SiO₂ (%) | 6.83 |
| 45.00 | 94.17 | P (%) | 0.092 |
| 37.00 | 90.65 | Al₂O₃ (%) | 2.47 |
| 25.00 | 79.65 | Mn (%) | 0.852 |
| 15.00 | 59.50 | TiO₂ (%) | 0.119 |
| 10.00 | 42.81 | CaO (%) | 0.012 |
| 6.00 | 25.77 | MgO (%) | 0.124 |
| 5.00 | 21.15 | PPC (%) | 2.84 |
| 4.00 | 16.47 | Blaine (cm²/g) | 5798 |
| 3.20 | 12.70 | Density (t/m³) | 4.54 |

### 2. Sludge Flotation Tailings:

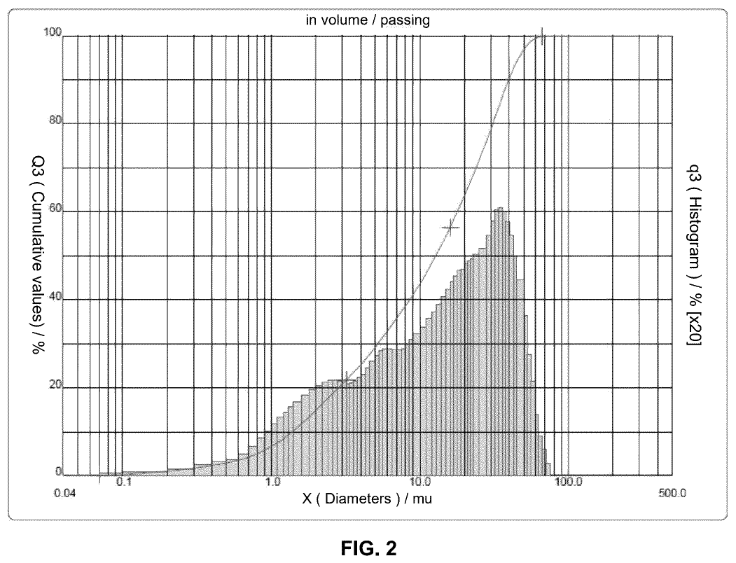

The sample was obtained from the homogenization of aliquots obtained in previous column flotation studies, with contents ranging from 11 to 22% Fe. FIG. 2 shows the particle size distribution of the tailings sample analyzed by laser beam diffraction (Cilas). The particles had an average diameter of approximately 11 μm, D10 of 1.2 μm, D50 of 8.6 μm and D90 of 25 μm. In particular, the high proportion of particles in the nano range (<1 μm).

### 3. Ultrafine Quartz:

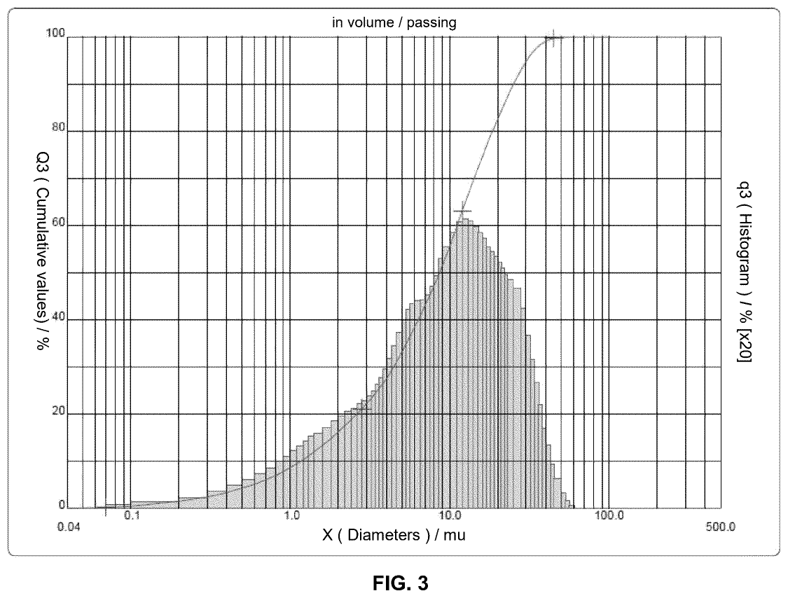

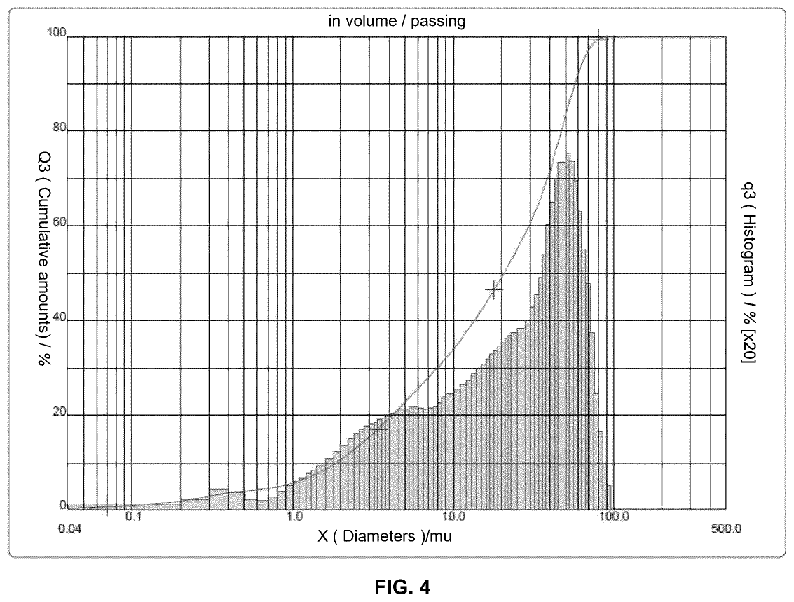

An extremely pure quartz mineral sample was used. FIGS. 3 and 4 show the particle size distribution of these samples (A1 and A2), with average diameters of 17 and 25 μm, respectively. Sample A1 has D10=1.4 μm, D50=13 μm and D90=40 μm and sample A2 has D10=2 μm, D50=21 μm and D90=57 μm.

### II. Methodology

### 1. Generation of Nanobubbles (NBs):

The NBs were generated using a saturator vessel (FIG. 1) coupled to a needle valve, by reducing the pressure of water pre-saturated with air to a pressure of 2.5 bar for 30 minutes, after passing through the flow constriction of the needle valve, where cavitation and the generation of bubbles occurred.

After the air-saturated water flow passed through the needle valve, there was selective separation of the microbubbles (MBs) generated concurrently during the process, since MBs have an upward velocity and reach the surface of the liquid. They reach the surface of the liquid, collapsing and leaving a dispersion of water containing a high concentration of NBs, in the order of 10⁸ NBs·mL⁻¹.

In the filtration tests with the application of NBs, this aqueous dispersion with a high concentration of NBs was used to prepare the mineral slurry used in the filtration.

In the pure quartz tests with amine conditioning (Flotigam EDA, Clariant®), a solution containing 75 mg·L⁻¹ of amine, with a surface tension close to 40 mN·m⁻¹, was used to generate NBs, resulting in a concentration of NBs in the order of 10⁹ NBs·mL⁻¹.

### 2. Filtration:

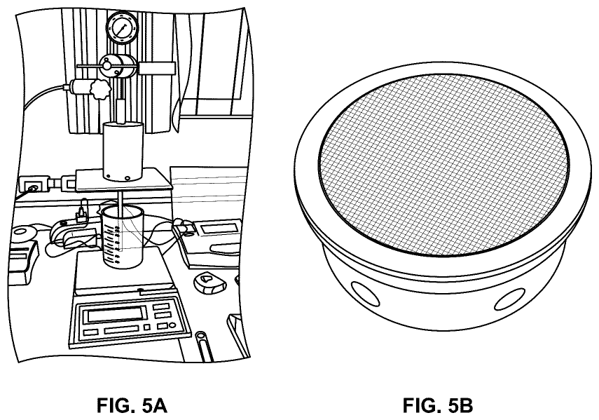

Bench-scale filter press equipment with compressed gas pressurization was used, brand Fann®, model HPHT 175 CT. The filtering system (see FIG. 5a) consists of a cylindrical stainless steel container that holds the slurry to be filtered and a filter media support chamber (see FIG. 5b), with a diameter of 54 mm (useful filtering area of 23 cm²), a CO₂ gas cylinder responsible for producing the pressure acting on the filter, pressure regulators and an analytical balance responsible for measuring the mass of filtrate leaving the filter over the test time.

The tests were carried out at a pH between 7 and 7.5, an operating pressure of 8 bar, 60% solids in the slurry and a volume of 100 mL used in each test. In the tests using sludge flotation tailings, the solids concentration used was 55% by mass, due to the higher viscosity of the slurry.

In the studies with quartz, amine conditioning (Flotigam EDA=50 g·t⁻¹) was carried out at pH 10 during slurry preparation. In the NB injection condition, the bubbles were generated using the procedure described in item 1 of this annex, using an amine solution (75 mg·L⁻¹) to fill the saturator vessel and generate a high concentration of NBs.

The experimental procedure begins with the preparation of the slurry (60% m/m of solids or 55% for the tailings), weighing the mass of solids and water. The mixture is stirred and the pH adjusted to the range described above. At the end of stirring, a volume of 100 mL of slurry is poured into the filter up to the defined mark and finally the filter medium is added to the support for coupling to the filter chamber, which has already been filled with mineral slurry. The filter is then closed with screws and placed on the support so that it is suspended over the scale. The pressure regulators are attached and set to 8 bar.

When the operating pressure reaches the inside of the filter, the valve below it is opened to allow the filtrate to escape and the timer is started. Filtering takes place from the opening of the valve until a puff of air appears, indicating that the flow of liquid has ceased and the drying stage has begun, which takes place for three minutes in all tests.

During the cake formation time, the mass of filtrate measured on the scale was recorded every 20 seconds to calculate the filtering speed. The end of the filtration cycle stage corresponding to the cake formation time is identified by the blowing of the gas percolating the cake on the inside of the filter and the cessation of the dripping flow of filtrate.

After the cake was formed, a fixed drying time of 3 min was maintained in all tests, in which the gas flow was kept constant and the pressure was fixed at 8 bar. At the end of the three minutes of drying, the air cylinder was closed and the test ended. The mass of the filter, together with the wet cake, was weighed and dried on a hotplate at 100° C. for at least 16 hours. After the cake has dried, it is weighed again on an analytical balance to calculate the moisture content of the cake after filtering.

After carrying out the tests without injecting the NBs, the same experimental procedure was repeated using the water with NBs (as described in paragraph [66]) to prepare the slurry for filtering.

### III. Results

### 1. Filtration of the Ultra-Fine Concentrate.

The results of the tests carried out to evaluate the performance of NB injection in the filtration of ultrafine iron ore concentrate slurry are shown in Table 2. The mean and standard deviation of the variables analyzed are shown in Table 3.

TABLE 2
Bench filtering of ultrafine iron ore concentrate, with and without NB injection. Conditions:
P = 8 atm; Temperature = 25° C.; Cake drying time (blowing) = 3 min; pH 7.

| | | | | FILTRATION | CAKE | CAKE |
|---|---|---|---|---|---|---|
| | | TURBIDITY | % SOLIDS | TIME | HEIGHT | HUMIDITY |
| TEST | CONDITION | (NTU) | (calculated) | (s) | (mm) | (%) |
| 1 | NO NBs | 41 | 59 | 92 | 21 | 16 |
| 2 | | 17 | 59 | 79 | 20 | 14 |
| 3 | | 30 | 60 | 71 | 21 | 13 |
| 4 | | — | 59 | 88 | 28 | 12 |
| 5 | | — | 60 | 115 | 25 | 16 |
| 6 | | 18 | 59 | 97 | — | 20 |
| 7 | | 22 | 59 | 100 | 26 | 20 |
| 8 | | 28 | 60 | 118 | 27 | 21 |
| 1 | WITH NBs | 40 | 60 | 68 | 21 | 15 |
| 2 | | 22 | 60 | 73 | 24 | 16 |
| 3 | | 33 | 59 | 57 | 20 | 12 |
| 4 | | — | 58 | 71 | 22 | 13 |
| 5 | | — | 60 | 75 | 21 | 15 |
| 6 | | 32 | 59 | 64 | — | 15 |
| 7 | | 23 | 58 | 65 | 24 | 16 |
| 8 | | 18 | 58 | 70 | — | 16 |

TABLE 3
Press filtration of ultrafine iron ore concentrate: Means and
standard deviations of the results obtained in Table 2 with
and without NBs. Conditions: P = 8 atm; Temperature = 25° C.;
Cake drying time (blowing) = 3 min; pH 7.

| | NO NBs | WITH NBs |
|---|---|---|
| | Mean \| | Mean \| |
| | Deviation | Deviation |
| AVERAGE | 95 \| 16 | 68 \| 5 |
| FILTERING | | |
| TIME (s) | | |
| AVERAGE | 15 \| 2 | 15 \| 1 |
| MOISTURE | | |
| OF CAKE (%) | | |

### 2. Tailings Filtration:

The results of the tests carried out to evaluate the performance of NB injection in the filtration of tailings slurry from iron sludge flotation are shown in Table 4. The mean and standard deviation of the variables analyzed are shown in Table 5.

TABLE 4
Press filtration of ultrafine iron ore tailings, with and without NB injection. Conditions:
P = 8 atm; Temperature = 25° C.; Cake drying time (blowing) = 3 min; pH 7.

| | | | | FILTRATION | CAKE | HUMIDITY |
|---|---|---|---|---|---|---|
| | | TURBIDITY | % SOLIDS | TIME | HEIGHT | CAKE |
| TEST | CONDITION | (NTU) | (calculated) | (s) | (mm) | (%) |
| 1 | NO NBs | 45 | 57 | 57 | 28 | 28 |
| 2 | | 52 | 55 | 93 | 26 | 29 |
| 3 | | 31 | 54 | 93 | 27 | 27 |
| 4 | | 25 | 55 | 81 | 28 | 28 |
| 5 | | 16 | 54 | 76 | 28 | 28 |
| 6 | | 35 | 54 | 79 | 26 | 28 |
| 7 | | 37 | 55 | 50 | 27 | 27 |
| 8 | | 28 | 54 | 63 | 27 | 27 |
| 9 | | 19 | 55 | 77 | 26 | 28 |
| 10 | | 35 | 57 | 61 | 29 | 26 |
| 11 | | 25 | 57 | 51 | 27 | 28 |
| 12 | | 35 | 57 | 52 | 27 | 28 |
| 1 | WITH NBs | 45 | 55 | 37 | 24 | 30 |
| 2 | | 50 | 55 | 52 | 27 | 29 |
| 3 | | 64 | 54 | 47 | 26 | 28 |
| 4 | | 22 | 55 | 70 | 28 | 29 |
| 5 | | 15 | 55 | 70 | 27 | 27 |
| 6 | | 36 | 55 | 84 | 27 | 27 |
| 7 | | 34 | 54 | 61 | 28 | 28 |
| 8 | | 35 | 54 | 55 | 24 | 28 |
| 9 | | 37 | 55 | 68 | 27 | 27 |
| 10 | | 22 | 57 | 64 | 26 | 26 |
| 11 | | 19 | 56 | 73 | 24 | 29 |
| 12 | | 27 | 57 | 65 | 24 | 25 |

TABLE 5
Press filtration of sludge flotation tailings: Means and
standard deviations of the results obtained in Table 4 with
and without NBs. Conditions: P = 8 atm; Temperature = 25° C.;
Cake drying time (blowing) = 3 min; pH 7.

| | NO NBs | WITH NBs |
|---|---|---|
| | Mean \| | Mean \| |
| VARIABLES | Deviation | Deviation |
| AVERAGE | 70 \| 16 | 62 \| 13 |
| FILTERING | | |
| TIME (s) | | |
| AVERAGE | 28 \| 1 | 28 \| 1 |
| MOISTURE | | |
| OF CAKE (%) | | |

### 3. Filtration of Ultrafine Quartz:

The results of the tests carried out to evaluate the performance of NB injection in the filtration of high purity ultrafine quartz slurry, with amine conditioning (50 g·t⁻¹) at pH 10 are shown in Table 6. The mean and standard deviation of the variables analyzed are shown in Table 7.

TABLE 6
Ultrafine quartz filter press, with and without NB injection.
Conditions: [amine] = 50 g · t⁻¹Flotigam, for 10 min; P = 8 atm;
Temperature = 25° C.; Cake drying time (blowing) = 3 min; pH 10.

| | | | | FILTRATION | CAKE | HUMIDITY |
|---|---|---|---|---|---|---|
| | | TURBIDITY | % SOLIDS | TIME | HEIGHT | CAKE |
| TEST | CONDITION | (NTU) | (calculated) | (s) | (mm) | (%) |
| 1 | NO NBs | 20 | 57 | 50 | | 15 |
| 2 | | 31 | 57 | 57 | | 16 |
| 3 | | 27 | 58 | 53 | | 16 |
| 1 | WITH NBs | 34 | 56 | 35 | 33 | 15 |
| 2 | | 15 | 57 | 44 | | 15 |

TABLE 7
Ultrafine quartz filter press: Means and standard deviations
of the results obtained in Table 6 with and without NBs. Conditions:
Conditions: [amine] = 50 g · t⁻¹, Flotigam,
for 10 min; P = 8 atm; Temperature = 25° C.;
Cake drying time (blowing) = 3 min; pH 10.

| | NO NBs | WITH NBs |
|---|---|---|
| | Mean \| | Mean \| |
| VARIABLES | Deviation | Deviation |
| AVERAGE | 53\| 3 | 40 \| 4 |
| FILTERING | | |
| TIME (s) | | |
| AVERAGE | 16 \| 1 | 15\| 0 |
| MOISTURE | | |
| OF CAKE (%) | | |

The main results showed no significant effects in relation to filtrate turbidity and cake moisture, with the use of water with and without NBs. However, the cake formation times (comparative results) were shorter for all samples in the presence of the nanobubbles:
1) In the filtration of iron ore concentrate slurries, the average reduction in cake formation time was 28%;
2) In the case of tailings slurry from sludge concentration, this reduction was 110% with NBs;
3) The filtration time of high purity ultrafine quartz samples, with (50 g·t−1) of amine, at pH 10, was 25% shorter with the injection of NBs.

The description given of the object of the present invention should be considered only as a possible embodiment or embodiments, and any particular characteristics introduced therein should be understood only as something that has been written to facilitate understanding. In this way, they can in no way be considered as limiting the invention, which is limited to the scope of the following claims.

1. A method for filtering particulate systems with nanobubble injection, comprising:
generating nanobubbles (NBs) through hydrodynamic cavitation techniques, after depressurizing the supersaturated liquid stream in compressed gas at saturation pressure between 1 and 15 bar;
promoting slurry conditioning/particle suspension in the presence of nanobubble dispersion (NBs) in the filtration feed line or auxiliary tanks; and
performing dewatering on slurry/particle suspension in filtration equipment using positive pressure, negative pressure (vacuum) or both,
wherein the nanobubbles (NBs) have an approximate diameter of less than 1 μm, and
wherein the method obtains fluid dispersions with a concentration of NBs between about 1×10⁶ NBs·mL⁻¹ and about 1×10¹² NBs·mL⁻¹.

2. The method according to claim 1, wherein the NBs are generated by alternative hydrodynamic cavitation methods selected from the group consisting of venturi tube, orifice plate and/or other flow constrictors, directly in-line in the slurry pipeline feeding the unit filtration operation.

3. The method according to claim 1, comprising generating NBs by alternative methods of ultrasonic cavitation (ultrasonic device) directly in-line in the slurry pipe feeding the unitary filtration operation.

4. The method according to claim 1, wherein the compressed gas is selected from air, carbon dioxide, inert gas, oxygen or mixtures thereof.

5. The method according to claim 1, comprising selectively separating the microbubbles (MBs) generated concurrently during the process.

6. The method according to claim 1, wherein the concentration of NBs is between about 1×10⁷ NBs·mL⁻¹ and about 1×10¹² NBs·mL⁻¹.

7. The method according to claim 1, comprising using additive filtration reagents with a surface tension between about 20 and about 72 mN·m⁻¹ for preparing the suspension of particulate solids with NBs.

8. The method according to claim 1 wherein the dewatering is carried out at a pH between about 6 and about 11.

9. The method according to claim 1 wherein the solids content in the slurry is between about 20% and about 85% by mass.

10. The method according to claim 1, wherein it is in the dewatering, particularly in the slurry of tailings and mineral concentrates prior to filtration in filter presses, vacuum filters or hyperbaric filters.

11. The method according to claim 7, wherein the surface tension is between about 30 and about 60 mN·m⁻¹.

12. The method according to claim 8, wherein the pH is between about 6.5 and about 9.

13. The method according to claim 8, wherein the pH is between about 7 and about 8.

14. The method according to claim 9, wherein the solids content is between about 40% and about 70% by mass.

15. The method according to claim 9, wherein the solids content is between about 45% and about 65% by mass.
